(19) United States
(12) Patent Application Publication
(10) Pub. No.: US 2002/0178857 A1
(43) Pub. Date: Dec. 5, 2002

(54) Steering column holding device for car

(75) Inventor: Takeshi Matsumiya, Gunma-ken (JP)

Correspondence Address: MILES & STOCKBRIDGE PC, 1751 PINNACLE DRIVE, SUITE 500, MCLEAN, VA, 22102-3833, US

(73) Assignee: NSK Ltd.

(21) Appl. No.: 10/157,482

(22) Filed: May 30, 2002

(30) Foreign Application Priority Data
Jun. 1, 2001 (JP) 2001-166362

(51) Int. Cl. B62D 1/18

(52) U.S. Cl. 74/493; 280/775

(57) ABSTRACT

A steering column holding device for a car for firmly holding a column side member mounted on a tiltable and telescopically adjustable steering column to a fixing member to car body mounted on a car body by means of a clamp mechanism, comprises at least a high friction material member for clamping the column side member to the fixing member to car body at the time of fastening the steering column by means of the clamp mechanism.

This application claims the benefit of Japanese Patent Application No. 2001-166362 which is hereby incorporated by reference.

### BACKGROUND OF THE INVENTION

1. Field of the Invention

The present invention relates to a steering column holding device for a car for firmly holding a tiltable and telescopically adjustable steering column assembly to a car body.

2. Related Background Art

For example, in a tilt-telescopic type steering apparatus disclosed in Japanese Patent Application Laid-Open No. 10-35511, a steering column is made tiltable and telescopically slidable, and the steering column is fastened and held such that a column side member mounted on the steering column is subjected to pressure-contacting against a fixing member to car body mounted on a car body, by means of a clamp mechanism. In particular, a number of thin metallic friction plates are disposed between the fixing member to car body and the clamp mechanism, whereby at the time of clamping by means of the clamp mechanism, the pressure-contacting and holding force of the steering column to the fixing member is greatly improved.

However, in the above steering column holding devices, since a number of metallic friction plates are used, there occurs a problem that manufacturing cost including material cost, machining cost and assembling cost becomes high. In addition, reduction of space for the column holding mechanism can not been achieved.

### SUMMARY OF THE INVENTION

In view of the above circumstances, the present invention is made, and it is an object of the present invention to provide a steering column holding device for a car capable of maintaining pressure-contacting and holding force of a steering column to a fixing member with high force, and reducing material cost, machining cost and assembling cost largely, and reducing space for the steering column holding device.

In order to achieve the above object, in a steering column holding device for a car for firmly holding a column side member provided on a tiltable and telescopically adjustable steering column to a fixing member to car body fixed on the side of a car body, by means of a clamp mechanism, at least a high friction material member is utilized to clamp the column side member to the fixing member to car body at the time of fastening the column side member at the tilt-adjusted or telescopically adjusted position to the fixing member to car body.

Thus, according to the present invention, at the time of clamping by means of the clamp mechanism, since the column side member is clamped to the fixing member to car body by the use of at least one high friction material member, pressure-contacting and holding force of the steering column to the car body can be increased significantly high. In addition, there is no need to utilize a number of metallic friction plates, so that material cost, machining cost and assembling cost can be greatly reduced, and space for the column holding mechanism can be reduced.

### BRIEF DESCRIPTION OF THE DRAWINGS

FIGS. 1A and 1B are schematic cross-sectional views of steering column holding devices for a car according to a first embodiment of the present invention;

FIGS. 2A and 2B are schematic cross-sectional views of steering column holding devices for a car according to a second embodiment of the present invention;

FIGS. 3A and 3B are schematic cross-sectional views of steering column holding devices for a car according to a third embodiment of the present invention;

FIGS. 4A and 4B are schematic cross-sectional views of steering column holding devices for a car according to a fourth embodiment of the present invention;

FIGS. 5A and 5B are schematic cross-sectional views of steering column holding devices for a car according to a fifth embodiment of the present invention;

FIGS. 6A and 6B are schematic cross-sectional views of steering column holding devices for a car according to a sixth embodiment of the present invention;

FIGS. 7A and 7B are schematic cross-sectional views of steering column holding devices for a car according to a seventh embodiment of the present invention;

FIGS. 8A and 8B are schematic cross-sectional views of steering column holding devices for a car according to an eighth embodiment of the present invention;

FIG. 9 is a side view of a steering column holding device for a car according to an example of the present invention;

FIG. 10 is a plan view of the steering column holding device in FIG. 9;

FIG. 11A is a side view of the high friction material disk and FIG. 11B is a coss-sectional view thereof; and

FIG. 12A is a side view of the long high friction material plate and FIG. 12B is a cross-sectional view thereof.

### DETAILED DESCRIPTION OF THE PREFERRED EMBODIMENTS

Steering column holding devices for a car according to embodiments of the present invention will be described hereinafter with reference to drawings.

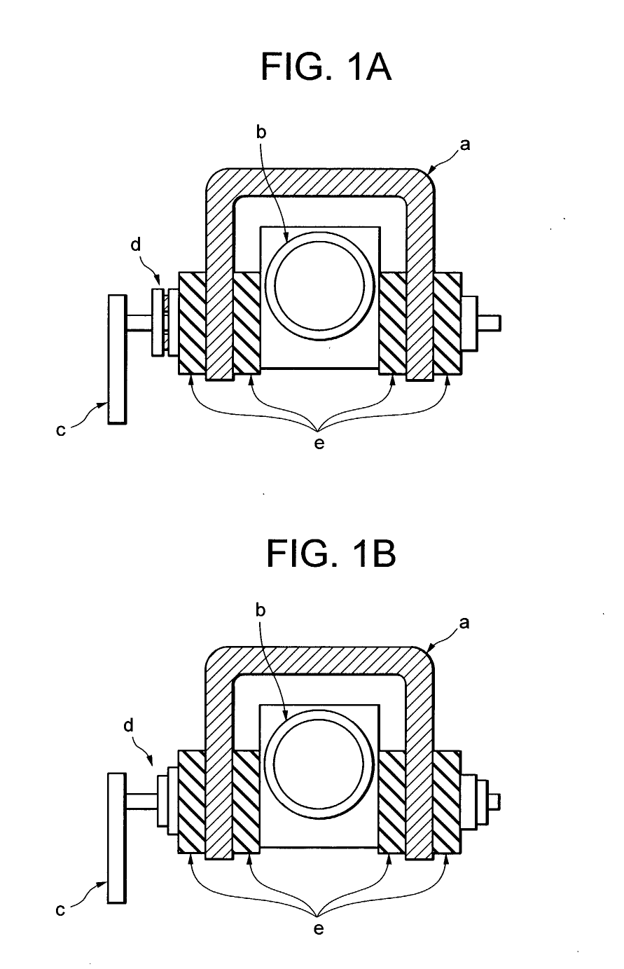

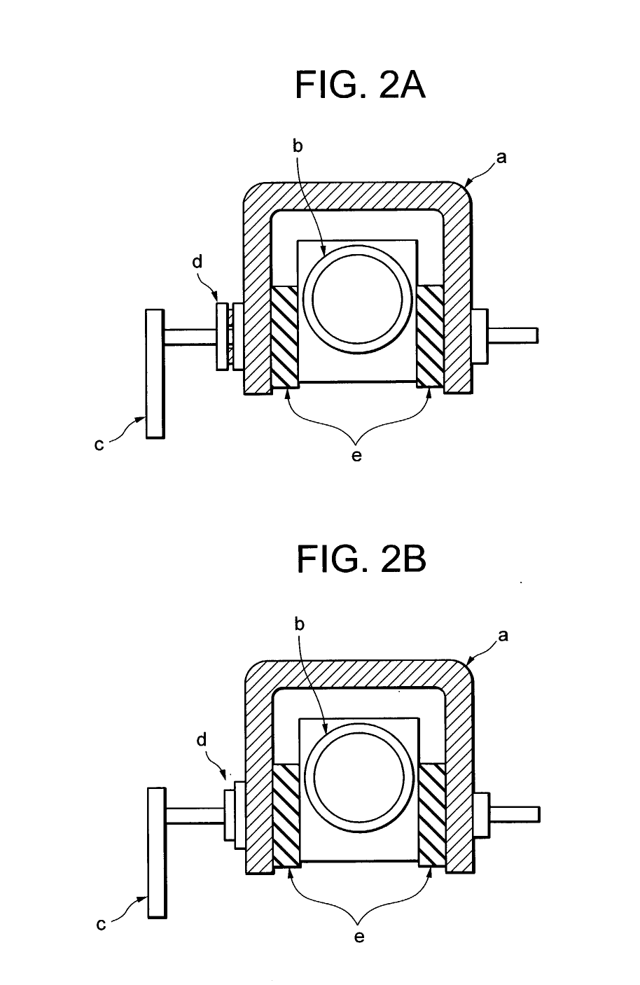

FIGS. 1A and 1B are schematic cross-sectional views of steering column holding devices for a car according to a first embodiment of the present invention. FIGS. 2A and 2B to FIGS. 8A and 8B are schematic cross-sectional views of respective steering column holding devices for a car according to second to eighth embodiments of the present invention.

Now, a first embodiment will be described with reference to FIGS. 1A and 1B.

In the first embodiment, a column shaft bearing b as a column side member of a tiltable and telescopically adjustable steering column is disposed inside a fixing member to car body a with a U-shaped cross section. The column shaft bearing b is subjected to pressure-contacting and held to the fixing bracket to car body a by a clamp mechanism d to be operated by a clamp lever c. In this embodiment and the following all embodiments, the clamp mechanism may be a well-known conventional one, and the detailed description thereof will be omitted.

In addition, the fixing bracket to car body a is formed integrally by a mounting portion to be mounted to a car body and side plate portions extending in parallel with each other from the mounting portion. The side plate portions are clamped tightly via inner and outer high friction material members e with each of the side plate portions sandwiched by the two high friction material members e, whereby the column shaft bearing is subjected to pressure-contacting and held to the fixing bracket to car body a. The clamp mechanism d has a supporting shaft, which pierces the side plate portions of the fixing bracket to car body a, the inner and outer high friction material members e and the column shaft bearing b. The clamp mechanism d is a cam mechanism type in FIG. 1A, and a screw adjustment or toggle type in FIG. 1B to subject the column shaft bearing b to pressure-contacting and to hold it via the high friction material members e.

The high friction materials of the inner and outer friction material members e are an asbestos-free type without utilizing asbestos. Basically, there are the following three types, but if a static friction coefficient is 0.45 or more, any one can be utilized among the three types as a base. However, one with high permanent set cannot be utilized since the holding force is weakened.

The high friction material members e are made of, for example, semi-metallic steel metal (used base material: 30 to 50% steel fiber, copper fiber), roll steel (used base material: 10 to 30% steel fiber, copper fiber) or non-steel (used base material: nonmetal such as aramid fiber, ceramic fiber, glass fiber). Besides, a Ferodo is used for reducing noise, but titanium potassium is not used, since it is harmful to a human body.

Ordinary, the high friction materials are joined to the backing plates under a hot bonding method. After oil is removed from iron plate as the backing plate, adhesive is applied on the iron plate and the high friction materials are placed thereon, which are then heated at hundred and tens degrees centrigrade, and whose surfaces are polished after cooled.

Further, the thickness of the high friction members e including the backing plate is about 1.5 to 2.0 mm, and the thickness of only the high friction materials is about 0.5 to 1.0 mm.

Thus, according to this embodiment, at the time of clamping via the clamp mechanism d, the column shaft bearing b is clamped to the fixing bracket to car body a via the high friction material members e, so that the holding force of the steering column to the car body can be increased significantly. In addition, as a number of metallic friction plates are not used, material cost, machining cost and assembling cost can be greatly reduced, and space for the column holding mechanism can be reduced.

Next, a second embodiment will be described with reference to FIGS. 2A and 2B.

In the second embodiment, only two inner high friction material members e for the respective lateral sides are used. The respective inner high friction material members e are attached to the side plate portions of the fixing bracket to car body a as the plate of the other material, by which the column shaft bearing b is pressed and held. The other structure is identical to that of the first embodiment, and the identical reference numbers are given to the identical members. The clamp mechanism d is a cam mechanism type in FIG. 2A and is a screw adjustment or toggle type in FIG. 2B.

Also in this embodiment, the pressure-contacting and holding force of the steering column to the fixing bracket to car body can be increased significantly. In addition, material cost, machining cost and assembling cost can be greatly reduced, and space for the column holding mechanism can be reduced.

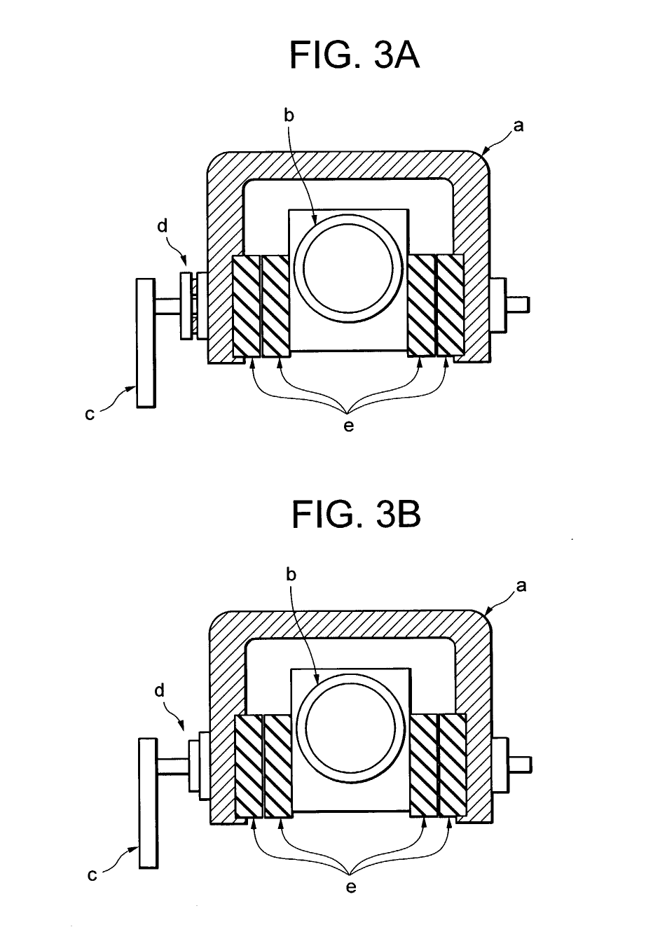

A third embodiment will be described with reference to FIGS. 3A and 3B.

In this embodiment, the high friction material members e fixed to the respective inside surfaces of both the side plate portions of the fixing bracket to car body a are in direct contact with the respective high friction material members e fixed to the column shaft bearing b to hold the steering column. The other structure is the same as that of the first embodiment, and the same reference numbers are given to the same members. The clamp mechanism d is a cam mechanism type in FIG. 3A, and a screw adjustment or toggle type in FIG. 3B.

Also in this embodiment, the pressure-contacting and holding force of the steering column to the fixing bracket to car body can be increased significantly. In addition, material cost, machining cost and assembling cost can be greatly reduced, and space for the column holding mechanism can be reduced.

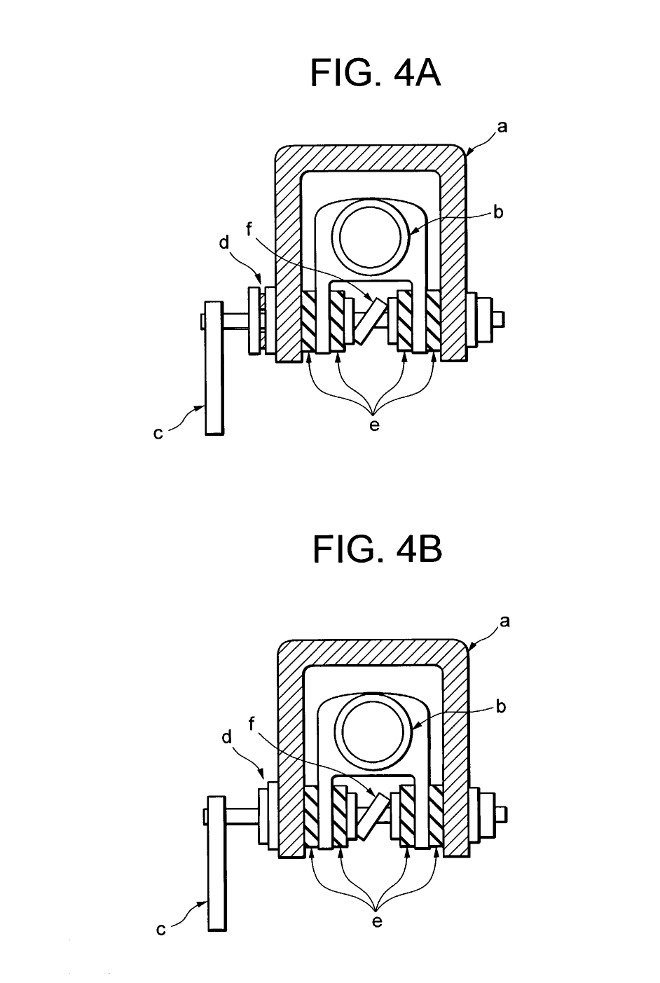

A fourth embodiment will be described with reference to FIGS. 4A and 4B.

In this embodiment, the structure of the lower portion of the column shaft bearing b is different from that of the above embodiments, and the column shaft bearing b has right and left leg portions. The high friction material members e are disposed respectively between the side plate portions of the fixing bracket to car body a and the right and left leg portions of the column shaft bearing b. In addition, the respective high friction material members e are provided inside the right and left leg portions. A cam mechanism f is provided between the high friction material members e, e. In such a structure, both the leg portions of the column shaft bearing b are tightly clamped and held via the clamp mechanism d. The other structure is the same as that of the first embodiment, and the same reference numbers are given to the same members.

The clamp mechanism d is a cam mechanism type in FIG. 4A, and a screw adjustment or toggle type in FIG. 4B.

Also in this embodiment, the pressure-contacting and holding force of the steering column to the fixing bracket to car body can be increased significantly. In addition, material cost, machining cost and assembling cost can be greatly reduced, and space for the column holding mechanism can be reduced.

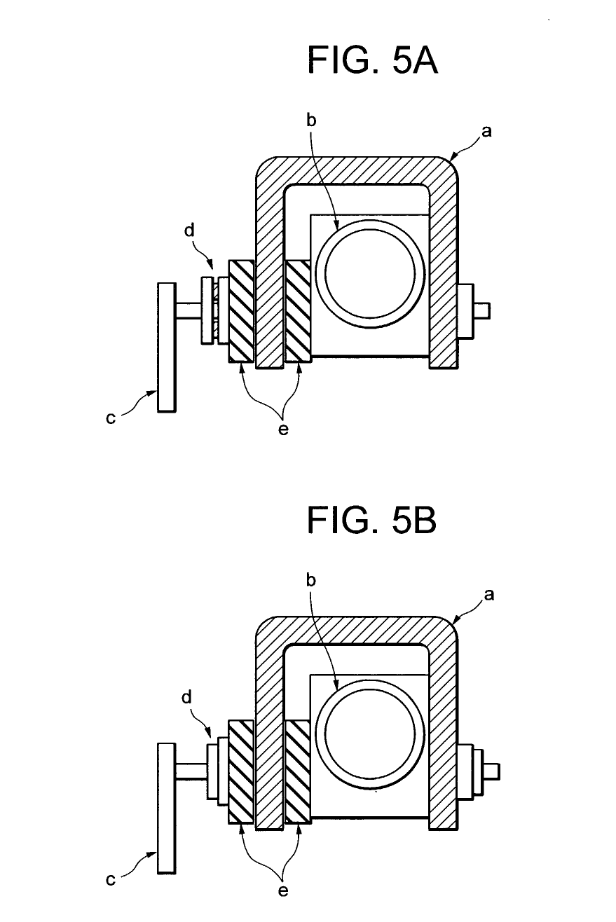

A fifth embodiment will be described with reference to FIGS. 5A and 5B.

In the fifth embodiment, only one side plate portion of the fixing bracket to car body a is clamped by two high friction material members e. The high friction material member is not used for the other side plate portion. The other structure is the same as in the first embodiment and the same reference numbers are given to the same members. The clamp mechanism d is a cam mechanism type in FIG. 5A, and a screw adjustment or toggle type in FIG. 5B.

Also in this embodiment, the pressure-contacting and holding force of the steering column to the fixing bracket to car body can be increased significantly. In addition, material cost, machining cost and assembling cost can be greatly reduced, and space for the column holding mechanism can be reduced.

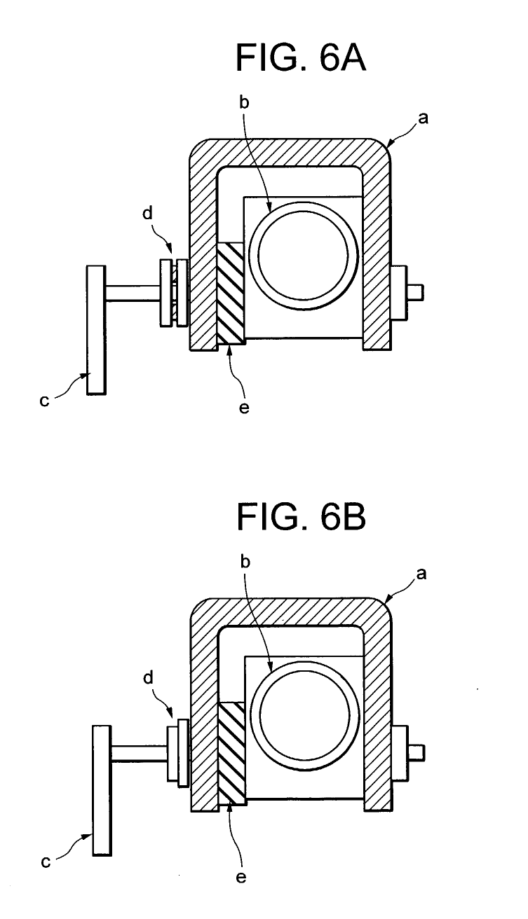

A sixth embodiment will be described with reference to FIGS. 6A and 6B.

In the sixth embodiment, the high friction material member e is interposed only between one side plate portion of the car body side holding bracket a and a corresponding side surface of the column shaft bearing b to hold the column shaft bearing b via pressure-contacting by means of the clamp mechanism d. The other structure is the same as in the second embodiment and the same reference numbers are given to the same members. The clamp mechanism d is a cam mechanism type in FIG. 6A, and a screw adjustment or toggle type in FIG. 6B.

Also in this embodiment, the pressure-contacting and holding force of the steering column to the fixing bracket to car body can be increased significantly. In addition, material cost, machining cost and assembling cost can be reduced largely, and space for the column holding mechanism can be reduced.

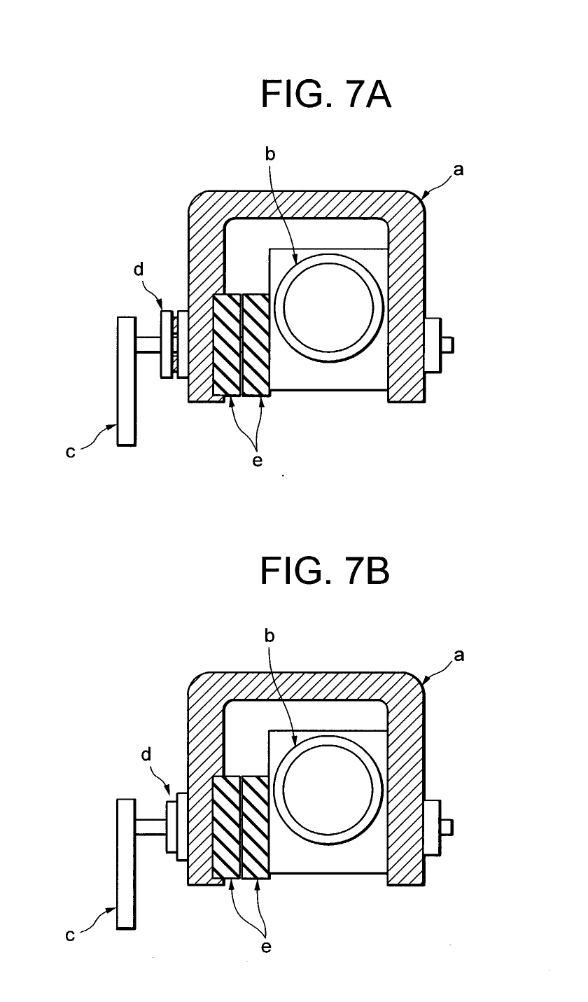

A seventh embodiment will be described with reference to FIGS. 7A and 7B.

In the seventh embodiment, the high friction material member fixed to one side plate portion of the fixing bracket to car body a and the high friction material member fixed to a corresponding one side portion of the column shaft bearing b are made indirect contact with each other to hold the column shaft bearing b via pressure-contacting by means of the clamp mechanism d. The other structure is the same as in the third embodiment, and the same reference numbers are given to the same members. The clamp mechanism d is a cam mechanism type in FIG. 7A and a screw adjustment or toggle type in FIG. 7B.

Also in this embodiment, the pressure-contacting and holding force of the steering column to the fixing bracket to car body can be increased significantly. In addition, material cost, machining cost and assembling cost can be greatly reduced, and space for the column holding mechanism can be reduced.

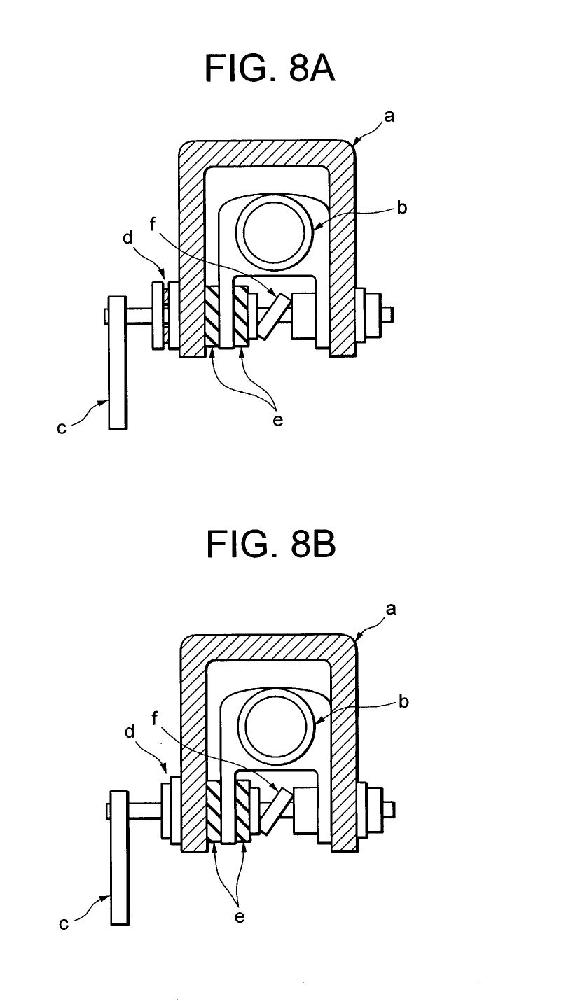

An eighth embodiment will be described with reference to FIGS. 8A and 8B.

In this embodiment, the structure of the lower portion of the column shaft bearing b is the same as that of the above fourth embodiment, and the column shaft bearing b has the right and left leg portions. One high friction material member e is interposed between one leg portion of the column shaft bearing b and one side plate portion of the fixing bracket to car body a, and the high friction material member e and the other high friction material member e sandwich the one leg portion of the column shaft bearing b to hold the column shaft bearing b via pressure-contacting by means of the clamp mechanism d.

The clamp mechanism d has a cam mechanism f on a center portion in addition to a cam mechanism on an end portion. In FIG. 8B, the clamp mechanism d has the cam mechanism f on a center portion in addition to a screw or a toggle on an end portion.

Also in this embodiment, the pressure-contacting, and holding force of the steering column to the fixing bracket to car body can be increased significantly. In addition, material cost, machining cost and assembling cost can be greatly reduced, and space for the column holding mechanism can be reduced.

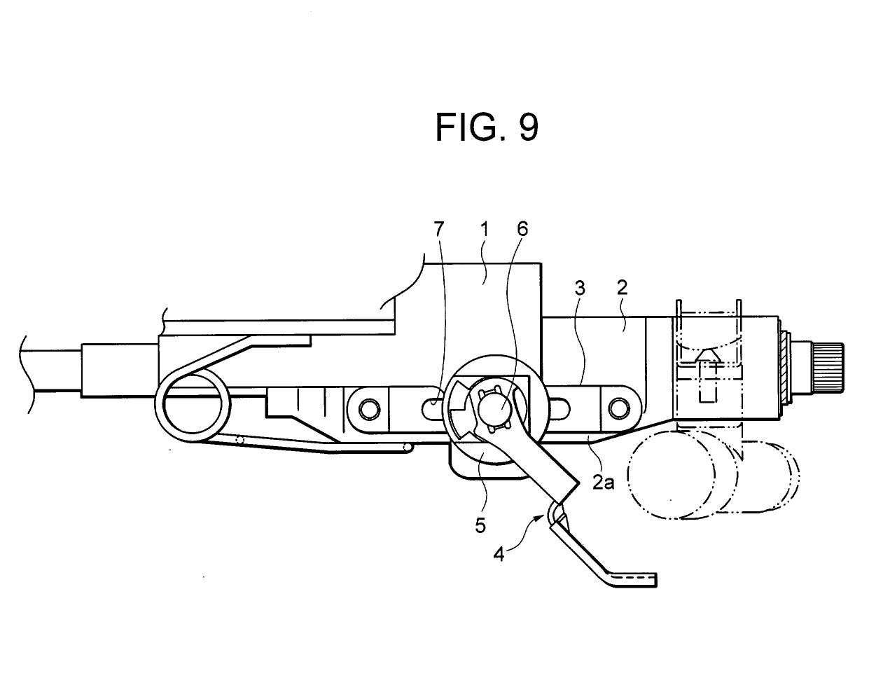

Next, a steering column holding device for a car according to an example of the present invention will be described with reference to FIGS. 9 to 12B.

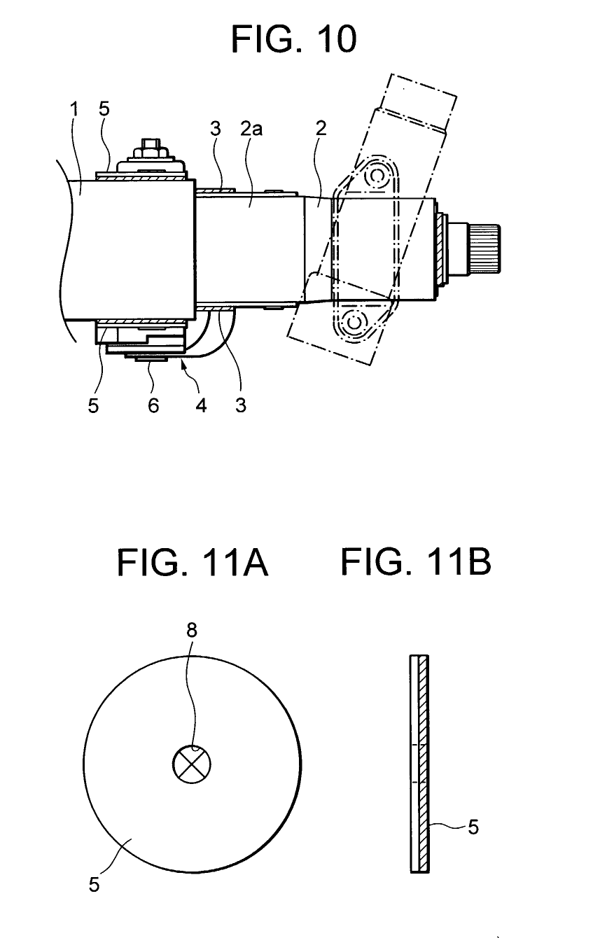

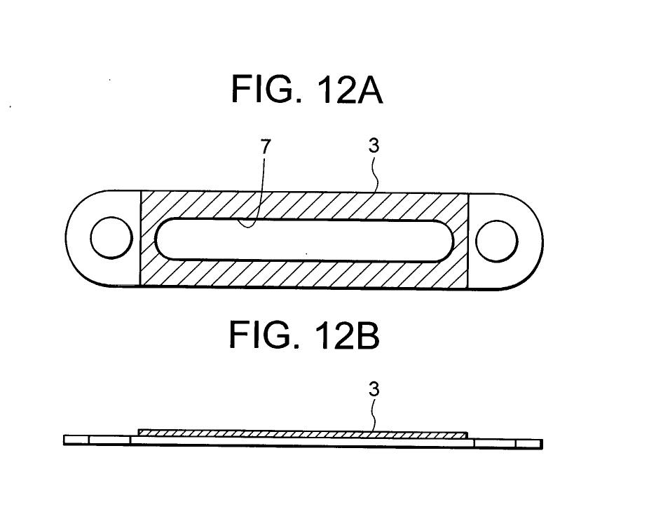

FIG. 9 is a side view of the steering column holding device of this embodiment. FIG. 10 is a plan view of the steering column holding device in FIG. 9. FIG. 11A is a side view of a high friction material disk, and FIG. 11B is a cross-sectional view thereof. FIG. 12A is a side view of a long high friction material plate, and FIG. 12B is a cross-sectional view thereof.

With respect to a fixing bracket to car body 1 fixed to a car body, a steering column 2 is made slidable in the axial direction. As shown in FIG. 12, long high friction material plates 3 are mounted to both side surfaces of a column shaft bearing 2a of the steering column 2 by means of screws. High friction material disks 5 as shown in FIG. 11A are provided inside a cam mechanism type clamp mechanism 4 so as to face the respective high friction material plates 3.

A fastening bolt 6 of the clamp mechanism 4 passes through elongated holes 7 of the long high friction material plates 3 and round holes 8 of the high friction material disks 5. The high friction material plates 3 and the high friction material disks 5 each are about 1 mm in thickness of high friction materials, and each has a backing plate of about 1 mm in thickness.

Thus, according to this example, at the time of clamping via the clamp mechanism 4, the column shaft bearing 2a is clamped to the fixing bracket to car body 1 by the use of the high friction material plates 3 and the high friction material disks 5, so that holding force (pressure contacting force) of the steering column to the car body can be greatly increased remarkably. In addition, since a number of metallic friction plates are not used, material cost, processing cost and assembling cost can be greatly reduced, and space for the column holding mechanism can be reduced.

The present invention is not limited to the above-mentioned embodiments, but various variations and modifications may be made without departing from the scope of the present invention.

What is claimed is:

1. A steering column holding device for a car for firmly holding a column side member mounted on a tiltable and telescopically adjustable steering column to a fixing member to car body mounted on a car body by means of a clamp mechanism, comprising:
at least a high friction material member for clamping said column side member to said fixing member to car body at the time of fastening said steering column by means of said clamp mechanism.

2. A steering column holding device for a car according to claim 1, wherein static friction coefficient of said high friction material meterial member is 0.45 or more.
